(19) United States
(12) Patent Application Publication
(10) Pub. No.: US 2012/0101941 A1
(43) Pub. Date: Apr. 26, 2012

(54) APPARATUS AND METHOD FOR GIRO CHARGE PAYMENT IN PORTABLE TERMINAL

(75) Inventors: Gi-Ryong KANG, Daegu (KR); In-Sil SHIN, Daegu (KR); Soon-Shik HWANG, Gyeongsangbuk-do (KR)

(73) Assignee: SAMSUNG ELECTRONICS CO., LTD., Gyeonggi-Do (KR)

(21) Appl. No.: 13/277,624

(22) Filed: Oct. 20, 2011

(30) Foreign Application Priority Data
Oct. 20, 2010 (KR) 10-2010-0102373

(51) Int. Cl. G06Q 20/32

(52) U.S. Cl. 705/40

(57) ABSTRACT

An apparatus and method for giro charge payment in a portable terminal are provided. The apparatus for giro charge payment in a portable terminal includes a camera unit and a control unit. The camera unit captures a barcode of a giro bill. The control unit extracts giro charge information from the barcode captured by the camera unit in a giro payment mode, and pays a giro charge by automatically inputting the extracted giro charge information on a giro charge payment screen of a mobile banking service.

### CLAIM OF PRIORITY

This application claims the benefit under 35 U.S.C. §119 of a Korean Patent Application filed in the Korean Intellectual Property Office on Oct. 20, 2010 and assigned Serial No. 10-2010-0102373, the entire disclosure of which is hereby incorporated by reference.

### BACKGROUND OF THE INVENTION

1. Field of the Invention

The present invention relates generally to an apparatus and method for effectuating a giro charge payment in a portable terminal, and more particularly, to an apparatus and method for giro charge payment through barcode recognition in a portable terminal.

2. Description of the Related Art

In general, a portable terminal enables voice, text, and video communication to a subscriber wireless. In addition, a portable terminal can record and store information and provide a game function.

For example, one of service features allows a subscriber of a portable terminal to place a group call. To achieve the group call service, users are previously registered in groups of multiple phone numbers, and a call signal is sent to the multiple grouped persons via a single call. Then, the caller can simultaneously talk on the phone with the group or send a text message. Another service allows an assignment of two phone numbers to a user.

Moreover, a wireless information service allows a subscriber to make a voice call and also transmit/receive data or fax even in a wireless area by simply connecting a portable terminal to a portable PC. A text information reception service allows a subscriber to receive a variety of information from a variety of fields, such as breaking news, big events, and so on.

Furthermore, another service enables a subscriber to pay for a bus fare or subway fare by contacting a part of the portable terminal to a card reader installed in a bus or subway station. An advanced customized public transportation (bus, subway, etc.) information service enables a subscriber to search the bus or subway routes, the shortest distance to the destination, and the time necessary to reach the destination. In a case in which a subscriber loses his or her own portable terminal or not in possession, he or she can use a wire telephone or other mobile phone to remotely control the services features, such as call barring, call forwarding, and voice mailbox forwarding.

A recent popular service known as a bank giro system provides an account transfer system between a payer and a payee. A bank giro system has extended the scope of application from the receipt of electricity bills and water bills to the remittance of payment for the goods, various usage fees, and membership dues as well as mass distribution affairs that individuals, companies, and government pay to several persons at the same time.

However, such a bank giro system is inconvenient in that persons must visit banks in person in order to pay bills, or must input all necessary information contained in a giro bill when using a mobile banking service of a PC or portable terminal.

Meanwhile, as a portable terminal is basically equipped with a camera unit, the function of checking product information and searching the price of products through barcode recognition is becoming popular.

However, the barcode recognition function through the camera unit of the portable terminal merely searches product numbers in a database and displays the prices of the searched products. Since the barcode recognition function of the portable terminal is mainly aimed at the product search, it is not used in the context of a giro bill application.

### SUMMARY OF THE INVENTION

An exemplary embodiment of the present invention is to provide an apparatus and method for giro charge payment through barcode recognition in a portable terminal.

According to an aspect of the present invention, an apparatus for giro charge payment in a portable terminal includes: a camera unit for capturing a barcode of a giro bill; and a control unit for extracting giro charge information from the barcode captured by the camera unit during a giro payment mode, and automatically inputting the extracted giro charge information on a giro charge payment screen of a mobile banking service for completing the payment of a giro charge.

According to another aspect of the present invention, an apparatus for giro charge payment in a portable terminal includes: a camera unit for capturing a barcode of a giro bill; and a control unit for extracting giro charge information from the barcode captured by the camera unit in a giro payment mode, displaying the extracted giro charge information and a number of payment methods for selection, and automatically paying a giro charge through a selected payment method.

According to another aspect of the present invention, a method for giro charge payment in a portable terminal includes: capturing a barcode of a giro bill in a giro payment mode by using a camera unit; extracting giro charge information from the captured barcode; and automatically inputting the extracted giro charge information on a giro charge payment screen of a mobile banking service for a subsequent payment of the giro charge.

According to another aspect of the present invention, a method for giro charge payment in a portable terminal includes: capturing a barcode of a giro bill by a camera unit in a giro payment mode; extracting giro charge information from the captured barcode, and displaying the extracted giro charge information; and automatically paying a giro charge through a selected payment method.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIG. 2 is a flow diagram illustrating a method for giro charge payment in a portable terminal according to an exemplary embodiment of the present invention; and

FIG. 3 is a flow diagram illustrating a method for giro charge payment in a portable terminal according to another exemplary embodiment of the present invention.

### DETAILED DESCRIPTION OF THE INVENTION

Exemplary embodiments of the present invention will be described below in detail with reference to the accompanying drawings. Like reference numerals in the drawings denote like elements.

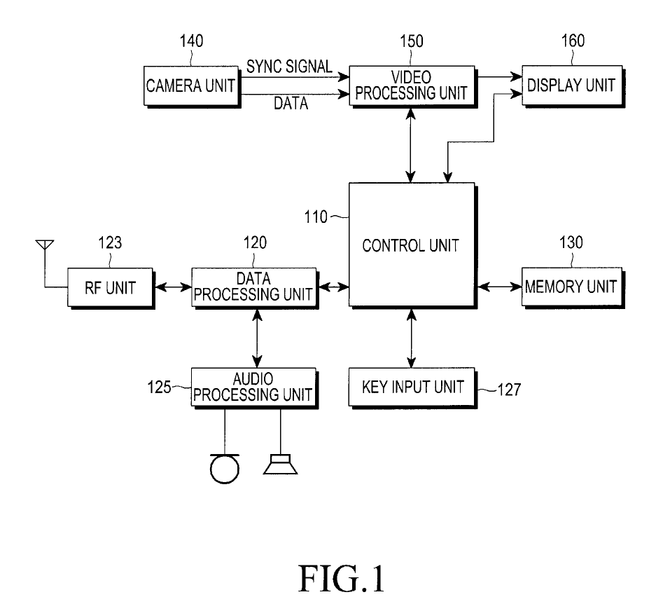

FIG. 1 is a block diagram of a portable terminal according to an exemplary embodiment of the present invention.

Referring to FIG. 1, a portable terminal according to an exemplary embodiment of the present invention includes a control unit 110, a data processing unit 120, a radio frequency (RF) unit 123, an audio processing unit 125, a key input unit 127, a memory unit 130, a camera unit 140, a video processing unit 150, and a display unit 160.

The RF unit 123 performs a wireless communication function of the portable terminal. The RF unit 123 includes an RF transmitter for upconverting and amplifying a transmission (TX) signal, and an RF receiver for low-noise-amplifying and downconverting a received (RX) signal. The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The key input unit 127 includes keys for inputting numeral and character information, and function keys for setting various functions.

The memory unit 130 may include a program memory and a data memory. The program memory may store programs for controlling a general operation of the portable terminal, and programs for performing a control operation to automatically input giro charge information, extracted from a barcode of a giro bill, to pertinent input boxes on a giro charge payment screen of a mobile banking service.

In addition, the program memory may store programs for performing a control operation to display the giro charge information, extracted from the barcode of the giro bill, and automatically pay the giro charge through a selected payment method (a mobile banking service or a portable terminal charge payment service).

The control unit 110 controls an overall operation of the portable terminal.

According to an exemplary embodiment, the control unit 110 automatically drives the camera unit 140 and the mobile banking service in a giro charge payment mode.

The control unit 110 extracts the giro charge information from the barcode of the giro bill captured by the camera unit 140 during the giro charge payment mode, and automatically inputs the extracted giro charge information to the pertinent input boxes on the giro charge payment screen of the mobile banking service.

According to an exemplary embodiment, as the giro charge information includes giro number, payer information, amount of payment, and due date for payment, the control unit 110 extracts only information necessary for the pertinent input boxes on the giro charge payment screen among the giro charge information, and displays the extracted information by automatically inputting the extracted information to the pertinent input boxes.

In this case, a previously registered payment bank and payment account may be automatically displayed in the pertinent input boxes on the giro charge payment screen of the mobile banking service.

According to an exemplary embodiment, if a modification is selected after the giro charge information is automatically inputted to the pertinent input boxes on the giro charge payment screen, the control unit 110 allows the user to modify the giro charge information.

According to another embodiment, the control unit 110 automatically drives the camera unit 140 in the giro charge payment mode, extracts the giro charge information from the barcode of the giro bill captured by the camera unit 140, and displays the extracted giro charge information on the display unit 160.

In the embodiment, the giro charge information includes giro number, payer information, amount of payment, and due date for payment.

According to another exemplary embodiment, if a payment method is selected while the extracted giro charge information is being displayed, the control unit 110 displays at least one bank application registered for a mobile banking service, a portable terminal charge payment service, and a payment application registration.

According to another embodiment, if the bank application registered for the mobile banking service is selected as the payment method, the control unit 110 performs a control operation to automatically pay the giro charge through the selected bank application.

According to another embodiment, if the portable terminal charge payment is selected as the payment method, the control unit 110 performs a control operation to automatically pay the giro charge through the portable terminal charge payment service.

According to another embodiment, if the payment application registration is selected as the payment method, the control unit 110 performs a control operation to register a selected new payment application.

The camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the digital processing unit may be integrated into one unit, or may be separated from each other.

According to an exemplary embodiment, the camera unit 140 is automatically driven in the giro charge payment mode to capture the barcode of the giro bill.

The video processing unit 150 performs an image signal processing (ISP) operation to display video signals, outputted from the camera unit 140, on the display unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the display unit 160. Also, the video processing unit 150 includes a video codec to compress the frame video data displayed on the display unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display size under the control of the control unit 110.

The display unit 160 displays the video signal outputted from the video processing unit 150, and displays the user data outputted from the control unit 110. The display unit 160 may be implemented using an LCD. If the display unit 160 is implemented using an LCD, the display unit 160 may include an LCD controller, a memory for storing video data, and an LCD panel. The LCD may be a touchscreen LCD. If the LCD is a touchscreen LCD, it may also operate as an input unit. Also, the display unit 160 may display the keys of the key input unit 127.

According to an exemplary embodiment, the display unit 160 displays the giro charge payment screen of the mobile payment service, on which the giro charge information extracted from the barcode is automatically inputted to the pertinent input boxes in the giro charge payment mode.

According to another embodiment, the display unit 160 displays the giro charge information extracted from the barcode in the giro charge payment mode.

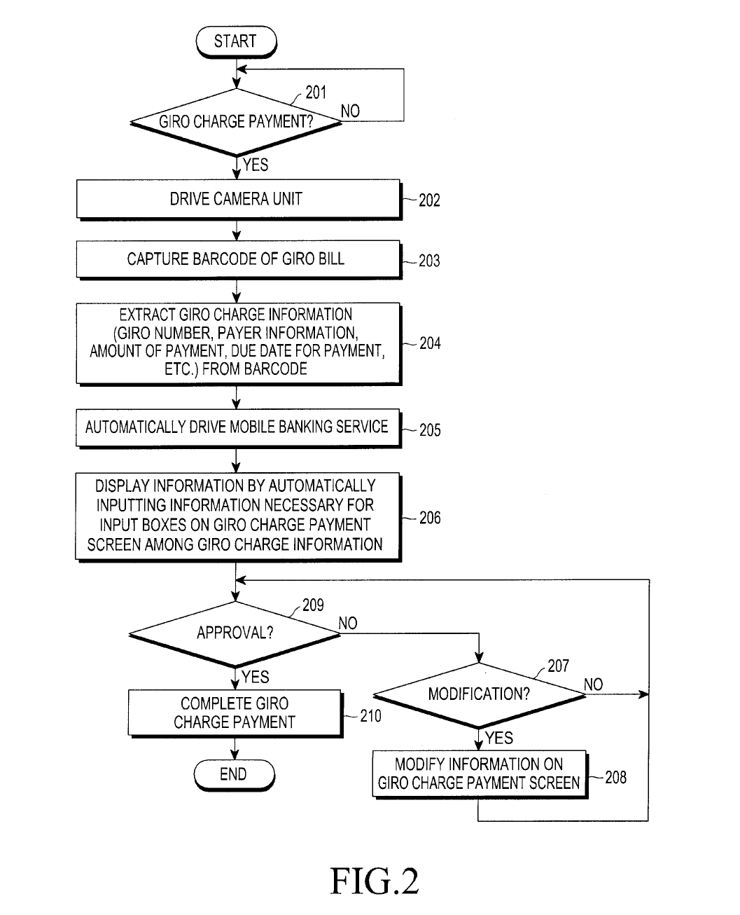

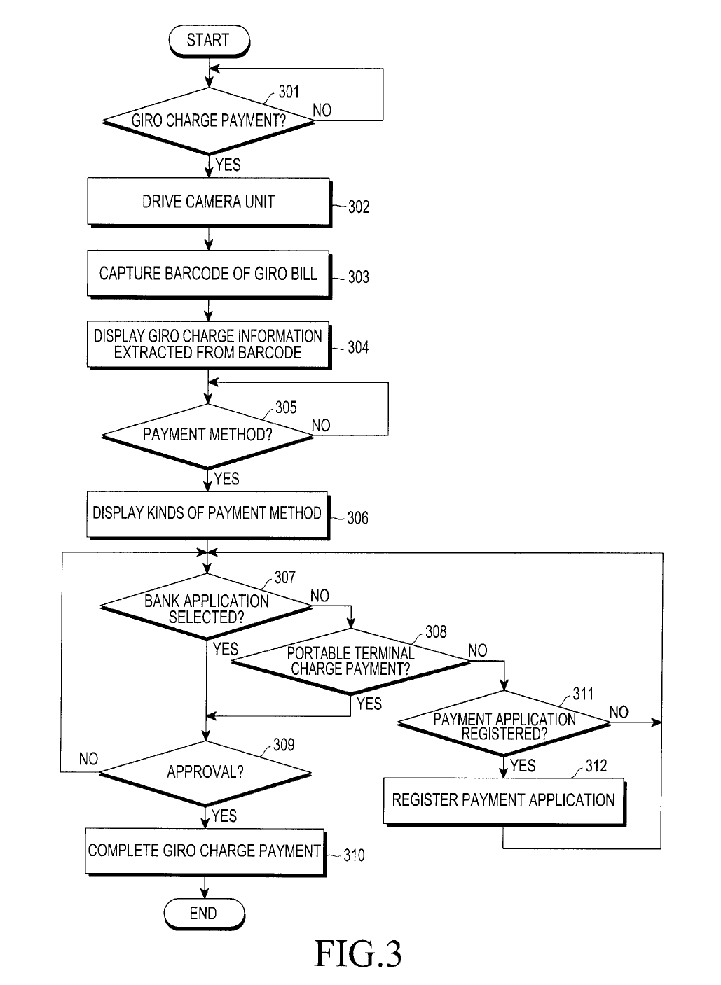

A process for controlling an application in the portable terminal according to an exemplary embodiment of the present invention will be described below in detail with reference to FIGS. 2 and 3.

Hereinafter, the embodiment of the present invention will be described in conjunction with FIG. 1.

Referring to FIG. 2, if the giro charge payment mode is selected in the portable terminal, the control unit 110 detects the selection in step 201, and the portable terminal switches to the giro charge payment mode.

In step 202, the control unit 110 automatically drives the camera unit 140 during the giro charge payment mode.

In step 203, if the barcode of the giro bill is captured by the camera unit 140, the control unit 110 detects the detected the barcode of the giro bill and proceeds to step 204. In step 204, the control unit 110 extracts the giro charge information from the captured barcode.

In the embodiment, the giro charge information extracted from the barcode in step 204 includes giro number, payer information, amount of payment, and due date for payment.

If the giro charge information is extracted (in step 204), the control unit 110 automatically executes the mobile banking service in step 205. The control unit 110 determines information necessary for the pertinent input boxes of the giro charge payment screen of the mobile banking service among the giro charge information. For example, if only the giro number and the amount of payment among the giro charge information are necessary, the control unit 110 extracts only the pertinent information (i.e., the giro number and the amount of payment) and proceeds to step 206. In step 206, the control unit 110 displays the giro number and the amount of payment by automatically inputting them to the pertinent input boxes on the giro charge payment screen.

The previously registered payment bank and payment account may be automatically inputted to the pertinent input boxes on the giro charge payment screen of the mobile banking service.

If the modification is selected by the user after the giro charge information is automatically inputted to the pertinent input boxes on the giro charge payment screen (in step 206), the control unit 110 detects the selection of the modification in step 207 and proceeds to step 208. In step 208, the user may modify the information inputted to the pertinent input boxes on the giro charge payment screen.

If the approval is inputted after the giro charge information is automatically inputted to the pertinent input boxes on the giro charge payment screen (in step 206), the control unit 110 detects the input of the approval in step 209 and completes the giro charge payment in step 210.

In the giro charge payment process using the mobile banking service in the portable terminal, the approval procedure for payment in the mobile banking service is a general mobile payment procedure and therefore a detailed description thereof will be omitted.

FIG. 3 is a flow diagram illustrating a method for giro charge payment in a portable terminal according to another exemplary embodiment of the present invention.

Hereinafter, the embodiment of the present invention will be described in conjunction with FIG. 1.

Referring to FIG. 3, if the giro charge payment mode is selected in the portable terminal, the control unit 110 detects the selection in step 301, and the portable terminal switches to the giro charge payment mode.

In step 302, the control unit 110 automatically drives the camera unit 140 in the giro charge payment mode.

In step 303, if the barcode of the giro bill is captured by the camera unit 140, the control unit 110 detects the capturing of the barcode of the giro bill and proceeds to step 304. In step 304, the control unit 110 extracts the giro charge information from the captured barcode and displays the extracted giro charge information on the display unit 160.

Since the giro charge information includes giro number, payer information, amount of payment, and due date for payment, the following information may be displayed in step 304.

KT Communication Service Fee
David, C. Smith
Amount of Payment: $37.30
Due Date: Aug. 03, 2010

If the payment method for displaying the giro charge information is selected (in step 304), the control unit 110 detects the selection of the payment method and proceeds to step 306. In step 306, the control unit 110 displays type of the payment methods on the display unit 160.

In step 306, the control unit 110 displays the payment method types, including at least one bank application previously registered for the mobile banking service, the portable terminal charge payment service, and the payment application registration.

For example, the kinds of the payment method in step 306 may be displayed as follows.

| | |
|---|---|
| 1. | Kookmin Bank (Account Number) |
| 2. | Woori Bank (Account Number) |
| 3. | Korea Exchange Bank (Account Number) |
| 4. | Payment App Registration |
| 5. | Portable Terminal Charge Payment |

If the “pertinent bank application” is selected among the payment methods displayed in step 306 and the approval is selected from the approval and cancel softkeys displayed together with the kinds of the payment method, the control unit 110 detects the selection of the pertinent bank application and the approval in steps 307 and 309 and proceeds to step 310. In step 310, the control unit 110 drives the mobile banking service and automatically pays the giro charge to the account number of the pertinent bank.

If the “portable terminal charge payment” is selected among the payment methods displayed in step 306 and the approval is selected from the approval and cancel softkeys displayed together with the kind of the payment method, the control unit 110 detects the selection of the portable terminal charge payment and the approval and proceeds to step 310. In step 310, the control unit 110 automatically pays the giro charge through the portable terminal charge payment service.

If the “payment application registration’ is selected among the payment methods displayed in step 306, the control unit 110 detects the selection of the payment application registration in step 311 and proceeds to step 312. In step 312, the control unit 110 registers a new bank application, selected or downloaded by the user, as the mobile banking service.

In the giro charge payment process using the mobile banking service in the portable terminal, the approval procedure for payment in the mobile banking service is a general mobile payment procedure and therefore a detailed description thereof will be omitted.

As described above, according to the exemplary embodiments, the subscriber can conveniently pay the giro charge by using the portable terminal.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for giro charge payment in a portable terminal, comprising:
a camera unit for capturing a barcode of a giro bill; and
a control unit for extracting giro charge information from the barcode captured by the camera unit in a giro payment mode, and for automatically inputting the extracted giro charge information on a giro charge payment screen of the terminal to process a mobile banking service.

2. The apparatus of claim 1, wherein the control unit extracts information necessary for input boxes on the giro charge payment screen among the giro charge information, and automatically inputs the extracted information to associated input boxes on the giro charge payment screen.

3. The apparatus of claim 1, wherein the control unit allows a user to selectively modify the giro charge information after the giro charge information is automatically inputted to the input boxes on the giro charge payment screen.

4. An apparatus for giro charge payment in a portable terminal, comprising:
a camera unit for capturing a barcode of a giro bill; and
a control unit for extracting giro charge information from the barcode captured by the camera unit during a giro payment mode, displaying the extracted giro charge information and displaying a plurality of payment methods, and automatically paying a giro charge through a selected payment method.

5. The apparatus of claim 4, wherein the control unit displays at least one bank application registered for a mobile banking service and a portable terminal charge payment when displaying the plurality of payment methods.

6. The apparatus of claim 5, wherein, when the payment method is selected, the control unit displays a payment application registration for allowing a user to register a new payment application.

7. The apparatus of claim 4, wherein the giro charge information includes giro number, payer information, amount of payment, and due date for payment.

8. The apparatus of claim 4, wherein the control unit displays at least one previously registered bank information in pertinent input boxes on a giro charge payment screen of the terminal when displaying the plurality of payment methods.

9. A method for giro charge payment in a portable terminal, comprising:
capturing a barcode of a giro bill in a giro payment mode by using a camera unit;
extracting giro charge information from the captured barcode; and
automatically inputting the extracted giro charge information on a giro charge payment screen of a mobile banking service for a subsequent payment of the giro charge.

10. The method of claim 9, wherein the extracting the giro charge information comprises:
extracting information necessary for input boxes on the giro charge payment screen among the giro charge information; and
automatically inputting the extracted information to the input boxes of the giro charge payment screen.

11. The method of claim 9, further comprising:
manually modifying the giro charge information, automatically inputted to the input boxes of the giro charge payment screen, when a modification is selected.

12. A method for giro charge payment in a portable terminal, comprising:
capturing a barcode of a giro bill by a camera unit in a giro payment mode;
extracting giro charge information from the captured barcode;
displaying the extracted giro charge information and a plurality of payment methods; and
automatically paying a giro charge through a selected payment method.

13. The method of claim 12, wherein displaying the plurality of payment methods comprises displaying at least one bank application registered for a mobile banking service and a portable terminal charge payment.

14. The method of claim 13, further comprising selecting and registering a new payment application if a payment application registration is selected among the plurality of the payment methods.

15. The method of claim 12, wherein the giro charge information includes giro number, payer information, amount of payment, and due date for payment.

16. The method of claim 12, wherein displaying the plurality of payment methods comprises displaying at least one previously registered bank information in pertinent input boxes on a giro charge payment screen of the terminal.
